(19) United States
(12) Patent Application Publication
(10) Pub. No.: US 2008/0033993 A1
(43) Pub. Date: Feb. 7, 2008

(54) Database Access Through Ontologies With Semi-Automatic Semantic Mapping

(75) Inventor: Rosario A. Uceda-Sosa, Hartsdale, NY (US)

Correspondence Address: CANTOR COLBURN LLP-IBM YORKTOWN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/462,385

(22) Filed: Aug. 4, 2006

(51) Int. Cl. G06F 17/00

(52) U.S. Cl. 707/104.1

(57) ABSTRACT

A method for accessing databases through ontologies by using an IRIS (Information Representation, Inferencing and Sharing) architecture that includes nodes and links, the method comprising: representing a graph model of the ontologies, where the ontologies include concepts, properties, and relations; defining the graph model through high-level constraints; using a plurality of agents to formulate queries of the ontologies; allowing sections of the ontologies to be named and used as classes; creating an interface module based on definitions of the relations created by the plurality of agents for evaluating the high-level constraints; allowing the semi-automatic mapping of data into the ontologies; loading the data into the ontologies; allowing the plurality of agents to access the ontologies through the queries; and customizing the ontologies through views derived from the queries.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to database access technologies, and particularly to database access through ontologies with semi-automatic semantic mapping.

2. Description of Background

Only recently have humans been able to envision an environment like the Internet, where intelligent agents, human or computational, interact with non-centralized, heterogeneous repositories of information. When all these repositories are organized in ontologies, agents are able to reason about things, not just data fields. For example, an address becomes an object that any agent can use, regardless of where or how it was created. Sharing the same vocabulary and semantics, millions of agents evolve and leverage a common information base of unprecedented size and richness. This is the design principle behind RDF (Resource Description Framework) and the core vision of the Semantic Web.

To make the Semantic Web a reality it is necessary to address the fact that the vast majority of structured data is currently in relational databases. This is not likely to change in the near future, as no other data model is as scalable and efficient for persisting and retrieving large amounts of data, especially in the corporate environment. Hence, tools need be designed that allow the database schemata and instances to be efficiently and systematically integrated with RDF-based ontologies.

It is well known that ontologies could be customized for specific domains and user tasks. However, in spite of their flexibility, ontologies use a vocabulary and class organization that may not suit the needs of arbitrary agents. Furthermore, current ontologies require an exact knowledge of the ontology configuration in order to allow agents to query both classes and instances. Therefore, it is desired to develop an ontology management system that enables the integration of databases and ontologies, and that allows the customization of ontologies by arbitrary agents, which is specifically useful in an environment like the Web.

### SUMMARY OF THE INVENTION

The shortcomings of the prior art are overcome and additional advantages are provided through the provision of a method for accessing databases through ontologies by using an IRIS (Information Representation, Inferencing and Sharing) architecture that includes nodes and links, the method comprising: representing a graph model of the ontologies, where the ontologies include concepts, properties, and relations; defining the graph model through high-level constraints; using a plurality of agents to formulate queries of the ontologies; allowing sections of the ontologies to be named and used as classes; creating an interface module based on definitions of the relations created by the plurality of agents for evaluating the high-level constraints; allowing the semi-automatic mapping of data into the ontologies; loading the data into the ontologies; allowing the plurality of agents to access the ontologies through the queries; and customizing the ontologies through views derived from the queries.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution, which enables the integration of databases and ontologies, and also allows the customization of ontologies by arbitrary agents.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of sample constraints in the Furniture Ontology;

FIG. 2 illustrates one example of a sample of tables schemata;

FIG. 3 illustrates one example of a sample instance query; and

FIG. 4 illustrates one example of a sample ontology sub-graph for metadata query.

### DETAILED DESCRIPTION OF THE INVENTION

One aspect of the exemplary embodiments is a mapping of database data to ontologies, which guides a user in producing an ontology that on top of being semantically consistent with database schema also extends and customizes such schema. Another aspect of the exemplary embodiments is a method that keeps mapping consistent through modifications and enhancements to the database and allows the database data to be accessed in the ontology in a scalable and efficient manner.

Ontologies are used in computer science, artificial intelligence, the Semantic Web, and software engineering as a form of knowledge representation about the world or some part of it. Ontologies are generally made up of: (i) concepts: objects and sets of objects (classes or categories), (ii) properties: the attributes of objects (slots, roles, or fields), and (iii) relations: models of how concepts are related to one another. Ontologies are a major piece of the Semantic Web framework. The ontology's ability to both classify data, and store reasoning rules about the data allows a computer (a user agent) to infer new knowledge from the knowledge stored.

Concepts and instances are the basic objects stored in an ontology. Concepts can represent entities, tasks, reasoning processes, functions or anything else in the domain(s) being modeled. They can also be viewed as sets of objects (instances) that share one or more common properties. Instances are the actual items from the domain.

To enable all this functionality, an IRIS (Information Representation, Inferencing and Sharing) is developed, which is an ontology infrastructure for the flexible access and customization of database data. The IRIS architecture consists of: A graph model that can represent and, in certain cases extend, RDF ontologies. This graph allows sections of the ontology to be named and used either as classes or as contexts to other queries. Furthermore, part of the graph topology can be defined through high-level constraints consistent to queries. An inferencing module based on the definitions of arbitrary relations created by agents. This module transparently evaluates constraints and views as the graph is navigated. A set of tools that allows the semiautomatic mapping of database data into the ontology and the loading of this data into the ontology is needed. A JSP (Java Server Page) based API (Application Programming Interface) allows agents to access the ontology through queries and to customize the ontology.

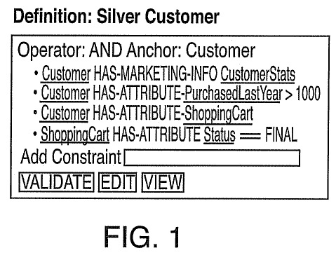

Turning now to the drawings in greater detail, FIG. 1 illustrates sample constraints when considering an online furniture catalog business.

Consider an online furniture catalog business, OLIE, which has a database with tables for furniture pieces, customer data, and transactions. OLIE desires to take advantage of the flexibility and power that the Semantic Web ontology technologies, like having its furniture catalog accessed and understood by search engines and other web applications. In OLIE's case, it is clear that any new ontology technology needs to be integrated with the corporate database without changing it. Furthermore, the current database needs to be preserved because it offers persistence and transaction services that ontologies do not have, apart from scalability unmatched in other data models. How can OLIE incorporate ontology technologies into its existing database, leveraging both the scalability and persistence services of the database and the flexibility and semantic organization of an ontology?

OLIE can use IRIS. IRIS stores information in spaces, which are networks of entities (classes and instances), relations among these entities, and views of areas of the ontology, together with inferencing knowledge for the intelligent navigation of the network.

An IRIS network is made up of nodes and links, which are extensions of nodes and links in more traditional graphs, like the RDF graphs. The nodes represent any RDF resource. For example, an IRIS node can represent a class like ‘Person’ or an ‘instance,’ like ‘John.’ However, IRIS nodes can also represent collections of IRIS graphs, which means they can also represent collections of RDF networks. For example, the ‘Person’ node can contain the ‘FirstName’ and ‘LastName’ properties. Nodes also contain graphs when they are used as contexts. For example a ‘CustomerContext’ node may contain ‘FurniturePiece’ and some of its properties, like the ‘RetailPrice,’ but not others, like the ‘WholeSalePrice.’

IRIS allows slots in nodes as a shortcut for a simple property in RDF. Conceptually, these are neighbors of the node where the links are implicit, like in the case of ‘Person’ and its properties ‘FirstName’ and ‘LastName.’ Hence, there are two types of content in a node. Slots and links are considered neighbors of the node, as they are in the same epistemological level as the node itself. Graphs or instances of a class are considered members of the node, as the node usually has constraints that regulate the membership to the node.

In IRIS, the membership content of a node can be described with a set of constraints that are dynamically evaluated as needed. An example, defining the class ‘Silver-Customer’ as a view of customers that have purchased more than 1000 dollars in the previous year is shown in FIG. 1.

The set of constraints has an anchor, which is a node where the evaluation starts. In this case, the anchor is the class ‘Customer.’ The remaining constraints refer to those sub-graphs that are included in this view. The constraint that restricts the instances to be part of this view is: ‘CustomerStats HAS-ATTRIBUTE PurchasedLastYear>=1000.’

The IRIS constraint language also includes cardinality and identity constraints on links. Variables can be defined to link constraints and define any sub-graph in the space, not just simple classes.

Relations are represented, as nodes with slots, which describe their structural properties, like ‘Name,’ ‘Arity,’ ‘Reflexivity,’ ‘Symmetry,’ ‘Transitivity,’ and ‘Inverse.’ All these properties are standard and they have the expected meaning in IRIS. There is also a semantic property of relations, ‘Semantic Dominance,’ which allows IRIS to navigate relations without knowing anything else about their specific semantics.

Given a binary relation R, it is semantically dominant in the first term if whenever aRb, a either precedes b temporally or causally, or a can be thought of a material or conceptual context for b. In other words, a precedes b in an order naturally induced by the semantics of the relation. A similar definition holds for relations that are semantically dominant in the second term or have no semantic dominance. For example, (1) ISA is dominant in the second term, (2) PARENT-OF is dominant in the first term, and (3) HAS-SIBLING has no semantic dominance. This notion of semantic dominance is a computational simplification of ‘Pierce’s Secondness' category.

Even though semantic dominance is, in some cases subjective, it works fairly well in practice. For example, if information is required to be known about a “FurniturePiece,” relations with no semantic dominance or semantic dominance in the second term can be navigable to obtain all the properties of the “FurniturePiece,” but not unrelated information. This heuristic guarantees that the search space is limited in order not to retrieve too much information or unrelated information.

Links are similar to the links in RDF graphs in that they are labeled with properties or relations that are themselves first order objects in the model.

Starting with a corporate database, it is assumed that someone who knows the schema of the database and becomes the ontology designer can create the initial ontology. The database is not required to be in any particular normal form, or place any constraints in the relation decomposition.

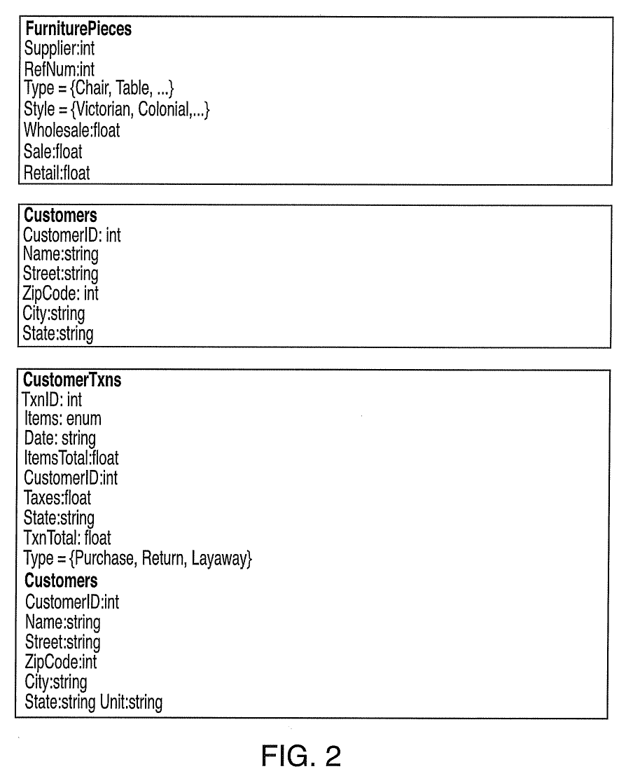

An illustration of this process with the schemata of FIG. 2 is described. The ontology is semi-automatically constructed from the database schema by identifying and characterizing several database entities which are associated to classes.

Column Groups, which are sets of columns that are related semantically. In this example, ‘Street,’ ‘ZipCode,’ and ‘City’ columns in ‘Customers’ becomes the ‘Address entity.’ It could also happen that the columns ‘ZipCode’ and ‘City’ are in a separate table. Each column group generates either a single class or a hierarchy of classes in the ontology.

Type Column Groups, which are special column groups whose values belong to an enumerated type and describe types of entities or properties of entities. ‘FurniturePieces:Style’ and ‘CustomerTxns:Type’ are examples of type columns.

Relations or properties are grouped in IRIS Relations Algebras, or I-Algebras. In IRIS, like in RDF, users can dynamically define relations and inferencing does not depend on specific relations. In practice, this generic inferencing is enough to provide flexible data access to the underlying ontologies.

An I-Algebra is a finite group of relations closed under composition and inverse. Specifically, it is a tuple I-Algebra={REL, <C, Runiversal, o, −1} where REL is a finite set of relations. <C is a partial order on REL defined as follows: R1<C R2 iff R1 is contained in R2. The pair {REL, <C} is the Relation Hierarchy.

REL has a special relation, Runiversal, which is the most general relation with respect to <C. The operation ‘o’ is relation composition, and −1 is inverse of relations. When defining relations, users place them in the hierarchy as refinements of already existing relations. IRIS does offer simple relations, like IS-A, HAS-ATTRIBUTE, HAS-MEMBER, etc. but these can be changed to suit the user's needs.

IRIS uses I-Algebras to identify the data that belongs to a given entity. In this scenario, if the user queries the information available on dining tables, the system obtains the ‘Style’ slot or the ‘Identifiers’ that are linked to the ‘FurniturePiece’ class automatically. This inferencing allows users to query a space without having to know all the details of the ontology organization.

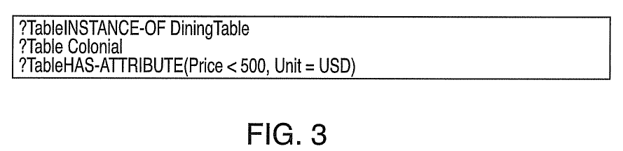

The constraint language of IRIS is designed to both retrieve instance data and concept data (or metadata) in queries. Furthermore, constraints can also be used to define new classes in the ontology as well as views and contexts. An IRIS query is a set of constraints that describes entities (classes or their instances) and their properties. For example, as shown in FIG. 3, the query below requests colonial DiningTable's with prices less than 500 dollars.

This example illustrates several characteristics of the query syntax. There needs to be at least one class that is referenced by name and can be used to start the evaluation. This is called the anchor of the query. In this case it is the class ‘DiningTable.’ User defined variables can be defined to relate the different constraints and they start with a question mark.

In order to query the ontology, users must know its basic vocabulary, which can be discovered through queries, but they do not need to know all the details of the underlying space. For example, users can ask for ‘Colonial DiningTable's’, as in the query above, regardless of whether ‘Colonial’ is the name of a class or the value of a slot. IRIS searches the subspace dominated by the ‘DiningTable’ class to locate the ‘Colonial’ tag. In an equivalent SQL query, users would have to select from the table ‘FurniturePieces where Style=Colonial.’

The result of the query above is a set of instances of ‘DiningTable’ with slots that satisfy the constraints. Constraints can be flagged to return their associated data in the result or not, which is similar to projection criteria in database terminology.

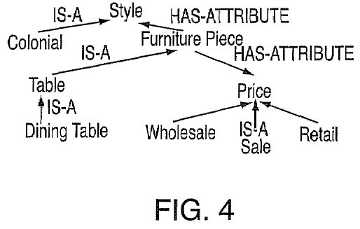

This constraint only requires that a table have at least one attribute Price to be selected and as a result all prices (Wholesale, Retail, Sale) are returned with the result. The example above returns a collection of instances, but one of the options of an IRIS query is to return metadata only. In this option, value constraints are ignored and the result is the section of the ontology described by the constraints, as shown in FIG. 4.

Another example of metadata query is simply FurniturePiece, which returns the sub-graph dominated by the FurniturePiece class. This sub-graph is determined by navigating relations that are semantically dominant in the second term. As another example of a metadata query, consider DiningTable HAS-ATTRIBUTE, which returns the attributes of DiningTable and the attributes of its super classes. This type of query allows the exploration of the ontology and uses the same syntax as instance queries, as shown in FIG. 4.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for accessing databases through ontologies by using an IRIS (Information Representation, Inferencing and Sharing) architecture that includes nodes and links, the method comprising:
representing a graph model of the ontologies, where the ontologies include concepts, properties, and relations;
defining the graph model through high-level constraints;
using a plurality of agents to formulate queries of the ontologies;
allowing sections of the ontologies to be named and used as classes;
creating an inferencing module based on definitions of the relations created by the plurality of agents for evaluating the high-level constraints;
allowing the semi-automatic mapping of data into the ontologies;
loading the data into the ontologies;
allowing the plurality of agents to access the ontologies through the queries; and
customizing the ontologies through views derived from the queries.

2. The method of claim 1, wherein the ontologies are RDF (Resource Description Framework) ontologies.

3. The method of claim 1, wherein the IRIS stores information in networks of entities, such as the classes, and the relations among the networks of entities together with inferencing knowledge.

4. The method of claim 3, wherein the inferencing knowledge is defined in IRIS Relation Algebra or I-Algebra.

5. The method of claim 1, wherein the nodes of the IRIS represent any RDF resource.

6. The method of claim 5, wherein each of the nodes of the IRIS includes two types of content, neighbor content and member content.

7. The method of claim 1, wherein the links of the IRIS represent the relations that are first-order objects in the graph model.

8. The method of claim 1, wherein the relations are represented as nodes with slots that describe structural properties.

9. The method of claim 1, wherein the high-level constraints retrieve instance data and metadata information in the queries.

10. The method of claim 1, wherein the high-level constraints define new classes, views, and contexts in the ontologies.

11. The method of claim 1, wherein the high-level constraints are categorized into sets, each set having an anchor node, the anchor node being a node where evaluation commences.

12. The method of claim 1, wherein the inferencing module allows a query of a space without the need to derive all details of an ontology organization.
